(19) United States
(12) Patent Application Publication
(10) Pub. No.: US 2009/0077812 A1
(43) Pub. Date: Mar. 26, 2009

(54) Eating utensil with integrated construction machine

(76) Inventors: Carter T. Malcolm, Ann Arbor, MI (US); Jacqueline K. Malcolm, Ann Arbor, MI (US)

Correspondence Address: CARTER MALCOLM, 1733 FOXDALE LANE, ANN ARBOR, MI, 48108, US

(21) Appl. No.: 11/903,214

(22) Filed: Sep. 21, 2007

(51) Int. Cl. B25F 1/00; A47J 43/28

(52) U.S. Cl. 30/142; 30/322; 30/324

(57) ABSTRACT

An eating utensil with an integrated construction machine where the functional aspects of the integrated construction machine (front loader scoop, bulldozer blade, fork lift tines, etc.) act as the functional aspects of the eating utensil (spoon, pusher, fork, etc.). The integration of the construction machines in such a manner provides entertainment for the user and encourages the use of the flatware.

### REFERENCES CITED

U.S. Patent Documents:

| | | |
|---|---|---|
| D 310,944 | October 1990 | Lutzker |
| D 389,719 | January 1998 | O'Hara et al. |
| D 404,260 | January 1999 | Lake et al. |
| D 404,261 | January 1999 | Lake et al. |
| D 407,274 | March 1999 | Lake et al. |
| D 437,740 | February 2001 | Manion et al. |

### BACKGROUND OF THE INVENTION

1. Field of the Invention

The present invention relates to eating and play/entertainment utensils. More particularly, it pertains to new construction themed feeding and play utensils which allows the user to emulate the true to life functioning of the machine to manipulate solids or liquids as needed to consume.

2. Description of the Prior Art

The prior art includes flatware utensils with ornamentation for decorative and entertainment purposes, but is devoid in integrating the portion of the utensil used to handle food with the entertainment ornamentation. The aforementioned patents do not disclose ornamentation comprised of construction equipment.

Known prior art includes U.S. Pat. No. 310,944; U.S. Pat. No. 389,719; U.S. Pat. No. 404,260; U.S. Pat. No. 404,261; U.S. Pat. No. 407,274; U.S. Pat. No. 437,740.

### DESCRIPTION OF RELATED APPLICATIONS

The inventors have previously submitted three design patents for related topics. The application numbers for those submissions are Ser. Nos. 29/258,542, 29/258,543, and 29/258,544.

### SUMMARY OF THE INVENTION

The general purpose of the present invention, which will be described subsequently in greater detail, is to provide new construction themed feeding utensils that embody true to life design of construction machinery with its active components newly designed as the functional portion of said utensils. None of the prior art includes the combination of the elements and theme of the present invention.

While other devices combine machines (airplanes, trains, etc.) with eating utensils, no aforementioned patents integrate the machines in a manner in which the functional aspects of the eating utensils are synonymous with the functional aspects of the machines; examples of this synonymous integration include, but are not limited to, the tines of a fork lift acting as a fork, the blade of a bulldozer acting as a pusher, and the scoop of a front loader acting as a spoon. Rather, the prior art includes various machines that are combined with eating utensils, but the machines are separate from the functional aspects of the eating utensils; for example, a spoon may appear to stick out of the front nose of an airplane, however, there is no distinct element on the front of the airplane that is morphed into the spoon.

### DESCRIPTION OF THE FIGURES

FIG. 1 is a perspective view of a spoon with integrated construction machine;

FIG. 2 is a perspective view of a fork with integrated construction machine;

FIG. 3 is a perspective view of a pusher with integrated construction machine.

### DESCRIPTION OF THE INVENTION

With reference to the figures, a new eating utensil embodying the concepts and principles of the present invention will be described.

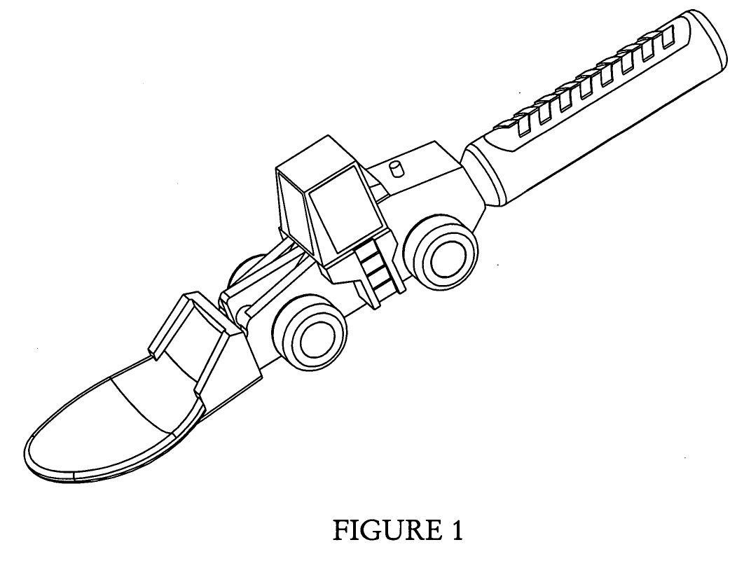

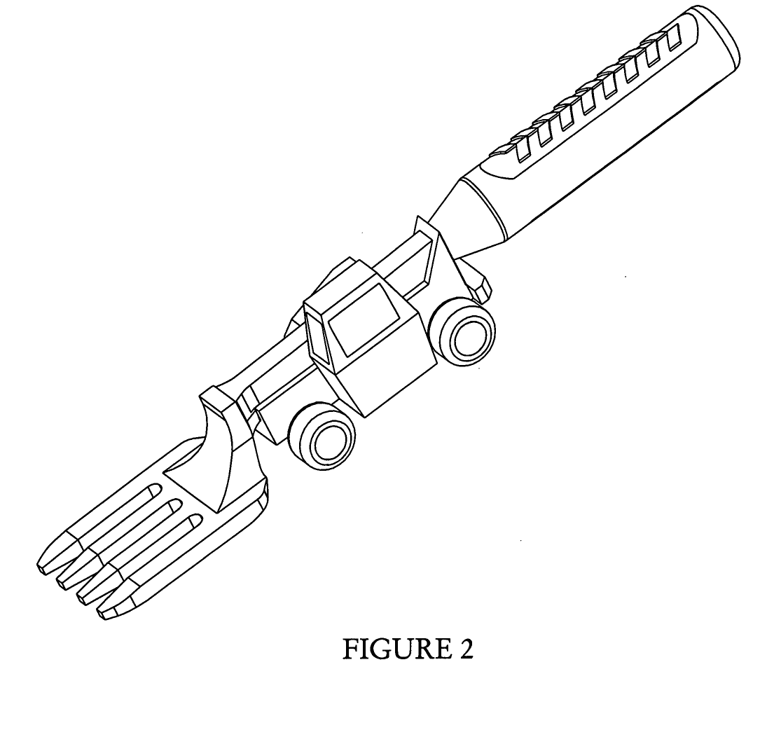

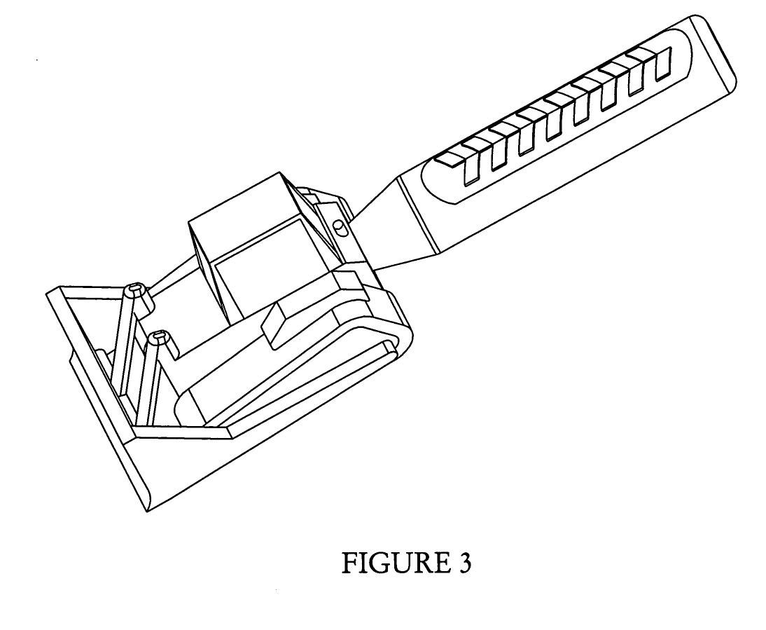

As best illustrated in FIGS. 1, 2 and 3, the eating utensil with integrated construction machine is comprised of a construction machine combined with an eating utensil. The functional aspect of the construction machine acts as the functional aspect of the eating utensil. This is demonstrated in FIG. 1 where the scoop of a front loader acts as a spoon, in FIG. 2 where the tines of a fork lift act as the tine of a fork, and in FIG. 3 where the blade of a bulldozer acts as a blunt implement of a pusher.

In use, the user would grip the eating utensil by the handle. The user would then manipulate either solids or liquids with the functional end of the utensil. The presence of the construction machine integrated into the utensil would provide entertainment for the user and encourage the independent or assisted use of the flatware.

While other devices combine machines (airplanes, trains, etc.) with eating utensils, no aforementioned patents integrate the machines in a manner in which the functional aspects of the eating utensils are synonymous with the functional aspects of the machines. Rather, the prior art includes various machines that are combined with eating utensils, but the machines are separate from the functional aspects of the eating utensils; for example, a spoon may appear to stick out of the front nose of an airplane, however, there is no distinct element on the front of the airplane that is morphed into the spoon.

It should be evident that this disclosure is by way of example and understood that the invention is capable of numerous changes, modifications and rearrangements such as the materials, coloring, size, and type of construction machine (including personifications of construction machines) without departing from the spirit of the present invention. Such changes, modifications and rearrangements are deemed readily apparent and obvious to one skilled in the art and all equivalent relationships to those illustrated in the figures and described in the specification are intended to be encompassed by the present invention.

Therefore, the foregoing is considered as illustrative only to the principles of the eating utensil with integrated construction machine. Further, since numerous modifications and changes will readily occur to those skilled in the art, it is not desired to limit the invention of the exact construction and operation shown and described, and accordingly, all suitable modifications and equivalents may be resorted to, falling within the scope of the invention.

We claim:

1. An eating utensil with an integrated construction machine where the functional aspect of the construction machine acts as the functional aspect of the eating utensil.

2. The blade on a construction machine (bulldozer, truck, snow removal machine, etc.) acting as a pusher on an eating utensil.

3. The bucket on a construction machine (front loader, back hoe, etc.) acting as a spoon on an eating utensil.

4. The tines on a construction machine (fork lift, boom fork lift, etc.) acting as a fork on an eating utensil.
